(19) United States
(12) Patent Application Publication
(10) Pub. No.: US 2024/0070741 A1
(43) Pub. Date: Feb. 29, 2024

(54) PROVIDING VISUAL INDICATIONS OF TIME SENSITIVE REAL ESTATE LISTING INFORMATION ON A GRAPHICAL USER INTERFACE (GUI)

(71) Applicant: MFTB Holdco, Inc., Seattle, WA (US)

(72) Inventors: Sangdi Lin, Seattle, WA (US); Egor Klevak, Seattle, WA (US); Joshua Urbanovsky, Seattle, WA (US); Michael Messenger, Seattle, WA (US); Ondrej Linda, Seattle, WA (US); Siddhi Vakil, Seattle, WA (US)

(21) Appl. No.: 17/898,953

(22) Filed: Aug. 30, 2022

(51) Int. Cl. G06Q 30/06; G06Q 30/02; G06Q 50/16

(52) U.S. Cl. CPC G06Q 30/0627; G06Q 30/0201; G06Q 30/0643; G06Q 50/165; G06F 16/29

(57) ABSTRACT

Systems and methods for providing visual indications of time sensitive real estate listing information on a Graphical User Interface (GUI) are disclosed. To provide users with visual indications of real estate listings that may sell soon with respect to a given region, the system uses days-sold information, real estate listing attributes, and user interaction data corresponding to a set of real estate listings associated with a given region to train a machine learning model to generate a selling soon prediction. The system then provides a days-on-market value, a set of home attributes, and user interaction data associated with a subject real estate listing as input to the machine learning model. The system then generates a selling soon prediction by applying the machine learning model and generates for display, on a GUI displaying information of the subject real estate listing, a visual indication of the selling soon prediction.

### BACKGROUND

Real estate databases may aid users (e.g., customers) while attempting to find a suitable home. When homes are high in demand with low supply, realtors often guess whether a real estate property will sell quickly based on their own personal opinion of the real estate market. This mere opinion, however, can lead real estate customers astray as there may be no data to back up the realtors opinion—which may result in a poor experience. Currently, real estate databases or systems have no mechanism to determine whether a home may sell quickly that would allow customers to make a more informed decision on whether they should buy a home that is currently available or if they have time to search for more suitable homes. These and other drawbacks exist.

### BRIEF DESCRIPTION OF THE DRAWINGS

FIG. 1 is a block diagram showing some of the components typically incorporated in at least some of the computer systems and other devices on which the disclosed system operates in accordance with some implementations of the present technology.

FIG. 2 is a system diagram illustrating an example of a computing environment in which the disclosed system operates in some implementations of the present technology.

FIG. 3 is a flow diagram illustrating a process of generating training data for one or more machine learning models, in accordance with some implementations of the present technology.

FIG. 4 shows a table of home attributes, in accordance with some implementations of the present technology.

FIG. 5 shows a graph illustrating one or more quantiles used to generate training data, in accordance with some implementations of the present technology.

FIG. 6 is a flow diagram illustrating a process of providing visual indications of time sensitive real estate listing information on a Graphical User Interface (GUI), in accordance with some implementations of the present technology.

FIGS. 7A-7B illustrate examples of visual indications of time sensitive real estate listing information on a GUI, in accordance with some implementations of the present technology.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

Customers are often against the clock when attempting to purchase homes during high real estate market demand with little supply. For example, a customer may only have a limited amount of time to put an offer in on a property before another customer does so. This can create excessive stress on the customer as the customer may not know whether to make an offer on a home or whether to keep searching for a more suitable home. For instance, when the real estate market is hot (e.g., high demand, low supply), customers may often purchase less suitable properties in fear of not being able to obtain a property at all, thereby leading to a poor experience. Currently, real estate databases have no mechanism for predicting which properties may sell fast, let alone in how many days a given property will sell. Considering that the demand for each real estate market is further influenced by the geographic region to which real estate properties are located only complicates any determination of whether a property will sell soon or not.

There is a need for determining, with respect to a given region, whether a real estate property will sell soon and how many days such property will sell. There is a further need for providing such time-sensitive information on a user interface such that customers are easily able to identify properties that may sell soon. Conventional systems may leverage realtor opinions (e.g., via manual input) to predict which properties may sell soon, however, such systems do not have a mechanism to determine which real estate properties, located in a given geographic region, will sell soon while considering home attributes of such real estate properties and any user interaction data.

To overcome these and other deficiencies of existing systems, the inventors have developed an system for determining whether a given real estate property will sell soon based on the region in which the property is located, how many days the real estate listing has been listed, home attributes of the real estate property, or user interaction data with the real estate listing. For instance, the inventors have developed a specialized machine learning model that uses such information to predict (i) whether the real estate property will sell soon (i) how many days the real estate listing will sell, and (iii) a probability associated with how fast the home will sell with respect to other real estate properties within the region in which the property is located. Furthermore, the inventors have developed an improved user interface such that a user may easily identify real estate listings (e.g., real estate properties) that may sell soon without wasting computer processing resources by manually interacting with a multitude of real estate listings, only for a real estate listing of interest to become unavailable, requiring the user to continue searching for real estate listings of interest.

For example, due to the amount of searching that is performed by a user to identify real estate listings of interest, there may be a large amount of time spent and computer resources required (e.g., such as memory, processing power, or other computer resources) to identify these real estate listings of interest to a user. However, during a real estate market with high demand and low supply, real estate listings of interest may become unavailable quickly. This may require the user to spend additional time and use unnecessary computer processing resources and may contribute to real estate database network traffic. Thus, by identifying real estate listings that may sell soon, users (e.g., customers) may be more inclined to purchase a property that is expected to sell soon, thus ending their search and conserving valuable computer processing resources and reducing network traffic.

In various implementations, the methods and systems described herein can determine (i) whether a real estate listing will sell soon, (ii) how many days until the real estate listing will sell, or (iii) a probability indicating how fast the real estate listing will sell with respect to other real estate listings in a given geographic region. For example, a machine learning model can be trained using how many days the real estate listing has been available, user interaction data associated with the real estate listing, home attributes of the real estate listing, and regional factors of a geographic region to which the real estate listing is located to provide such determinations. Based on one or more of the determinations (e.g., whether the real estate listing will sell soon, how many days until the real estate listing will sell, the probability indicating how fast the real estate listing will sell, etc.), the system generates for display, a visual indication of such determinations to aid users in making a time-sensitive choice on whether to purchase the real estate listing.

In the following description, for the purposes of explanation, numerous specific details are set forth in order to provide a thorough understanding of implantations of the present technology. It will be apparent, however, to one skilled in the art that implementation of the present technology can practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Suitable Computing Environments

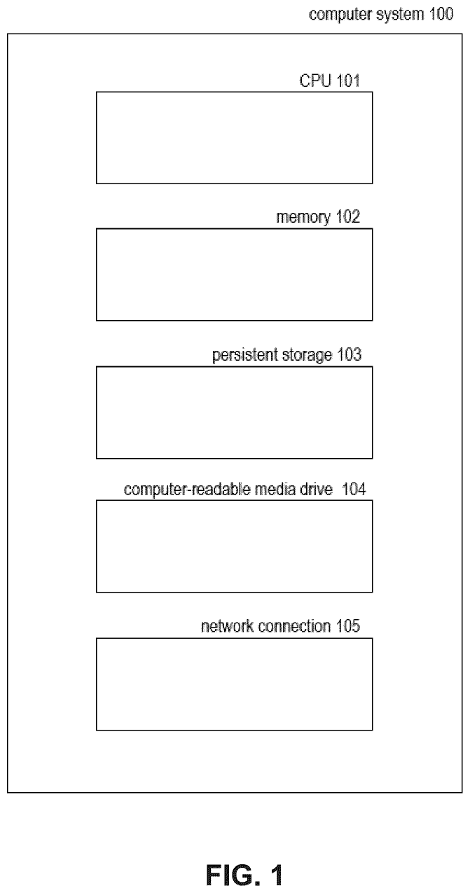

FIG. 1 is a block diagram showing some of the components typically incorporated in at least some of the computer systems and other devices on which the disclosed system operates. In various implementations, these computer systems and other devices 100 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various implementations, the computer systems and devices include zero or more of each of the following: a central processing unit (CPU) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; computer-readable media drives 104 (e.g., at least one non-transitory computer-readable medium) that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

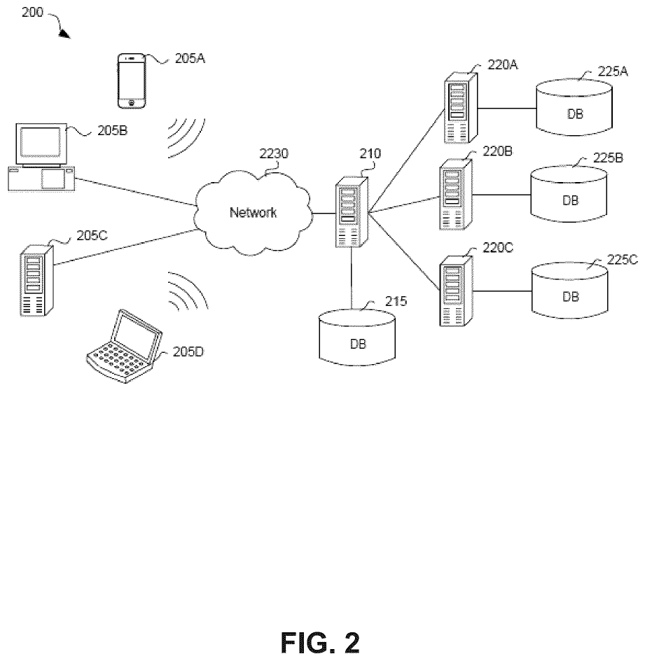

FIG. 2 is a system diagram illustrating an example of a computing environment in which the disclosed system operates in some implementation. In some implementations, environment 200 includes one or more client computing devices 205A-D, examples of which can host the system 100. For example, the computing devices 205A-D can comprise distributed entities 1-4, respectively. Client computing devices 205 operate in a networked environment using logical connections through network 2230 to one or more remote computers, such as a server computing device.

In some implementations, server computing device 210 is an edge server which receives client requests and coordinates fulfillment of those requests through other servers, such as servers 220A-C. In some implementations, server computing devices 210 and 220 comprise computing systems, such as the system 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server or client devices. In some implementations, servers (210, 220A-C) connect to a corresponding database (215, 225A-C). As discussed above, each server 220 can correspond to a group of servers, and each of these servers can share a database or can have its own database. Databases 215 and 225 warehouse (e.g., store) information such as real estate listings, home information, recent sales, home attributes, particular homes, subject homes, comparable homes, home data, actual values of homes, predicted values of homes, automated valuation models, model data, training data, test data, validation data, one or more machine learning models, partitions of homes, confident home values, updated predicted values of homes, predefined ranges, predefined thresholds, error thresholds, graphical representations, interquartile ranges of actual values, quantiles of actual values, upper quartiles of actual values, lower quartiles of actual values, bin threshold values, market or location, time or seasons, types of homes, model performance, confidence bin performance, sale prices, listing prices, and so on.

The one or more machine learning models can include supervised learning models, unsupervised learning models, semi-supervised learning models, and/or reinforcement learning models. Examples of machine learning models suitable for use with the present technology include, but are not limited to: regression algorithms (e.g., ordinary least squares regression, linear regression, logistic regression, stepwise regression, multivariate adaptive regression splines, locally estimated scatterplot smoothing), instance-based algorithms (e.g., k-nearest neighbor, learning vector quantization, self-organizing map, locally weighted learning, support vector machines), regularization algorithms (e.g., ridge regression, least absolute shrinkage and selection operator, elastic net, least-angle regression), decision tree algorithms (e.g., classification and regression trees, Iterative Dichotomiser 3 (ID3), C4.5, C5.0, chi-squared automatic interaction detection, decision stump, M5, conditional decision trees), Bayesian algorithms (e.g., naïve Bayes, Gaussian naïve Bayes, multinomial naïve Bayes, averaged one-dependence estimators, Bayesian belief networks, Bayesian networks), clustering algorithms (e.g., k-means, k-medians, expectation maximization, hierarchical clustering), association rule learning algorithms (e.g., apriori algorithm, ECLAT algorithm), artificial neural networks (e.g., perceptron, multilayer perceptrons, back-propagation, stochastic gradient descent, Hopfield networks, radial basis function networks), deep learning algorithms (e.g., convolutional neural networks, recurrent neural networks, long short-term memory networks, stacked auto-encoders, deep Boltzmann machines, deep belief networks), dimensionality reduction algorithms (e.g., principle component analysis, principle component regression, partial least squares regression, Sammon mapping, multidimensional scaling, projection pursuit, discriminant analysis), time series forecasting algorithms (e.g., exponential smoothing, autoregressive models, autoregressive with exogenous input (ARX) models, autoregressive moving average (ARMA) models, autoregressive moving average with exogenous inputs (ARMAX) models, autoregressive integrated moving average (ARIMA) models, autoregressive conditional heteroskedasticity (ARCH) models), and ensemble algorithms (e.g., boosting, bootstrapped aggregation, AdaBoost, blending, stacking, gradient boosting machines, gradient boosted trees, random forest).

In various implementations, the one or more machine learning models can be trained on training data or a training set (discussed in more detail below). The training data or training set can be created by generating pairs of features (e.g., feature vectors) and/or ground-truth labels/values based on any of the data stored in databases 215 and 225. During training, the machine learning models can be adjusted or modified to fit the models to the training data by, e.g., adjusting or modifying model parameters, such as weights and/or biases, so as to minimize some error measure (e.g., a difference between a predicted value and an actual/ground-truth value) over the training data. The error measure can be evaluated using one or more loss functions. Examples of loss functions that can be used include, but are not limited to, cross-entropy loss, log loss, hinge loss, mean square error, quadratic loss, L2 loss, mean absolute loss, L1 loss, Huber loss, smooth mean absolute error, log-cosh loss, or quantile loss. The trained machine learning models can then be applied to test data or validation data (e.g., holdout dataset) to generate predictions (e.g., predicted values or labels). The test data or validation data can also come from data that is stored in databases 215 and 225 (e.g., unlabeled data to generate predictions for). In some implementations, the machine learning models can be retrained to further modify/adjust model parameters and improve model performance. The machine learning models can be retrained on existing and/or new training data, training data, or validation data so as to fine-tune the model parameters to better fit the data and yield a different error measure over the data (e.g., further minimization of the error, or to increase the error to prevent overfitting). More specifically, the model can be further adjusted or modified (e.g., fine-tuned model parameters such as weights and/or biases) so as to alter the yielded error measure. Such retraining can be performed iteratively whenever it is determined that adjustments or modifications to the machine learning models are desirable.

Though databases 215 and 225 are displayed logically as single units, databases 215 and 225 can each be a distributed computing environment encompassing multiple computing devices, can be located within their corresponding server, or can be located at the same or at geographically disparate physical locations.

Network 2230 can be a local area network (LAN) or a wide area network (WAN), but can also be other wired or wireless networks. In some implementations, network 2230 is the Internet or some other public or private network. Client computing devices 205 are connected to network 2230 through a network interface, such as by wired or wireless communication. While the connections between server computing device 210 and server computing device 220 are shown as separate connections, these connections can be any kind of local, wide area, wired, or wireless network, including network 2230 or a separate public or private network.

### Generating Training Data

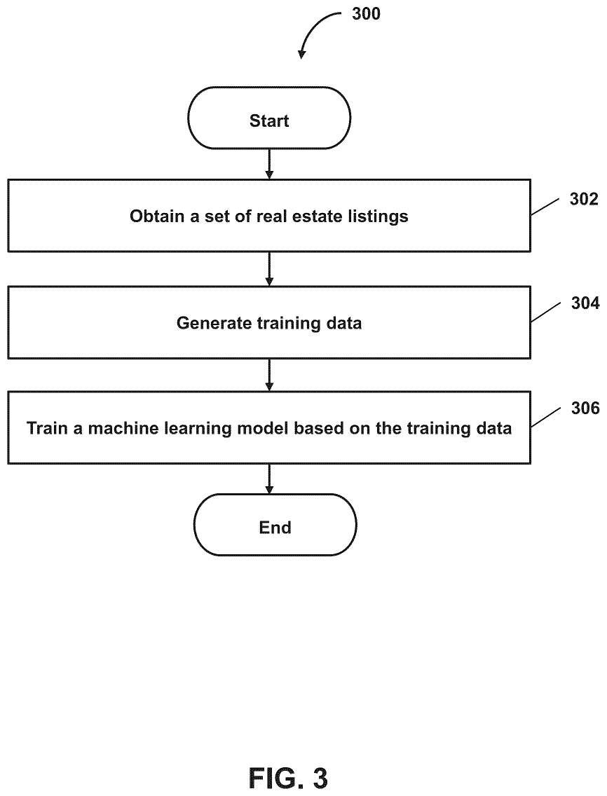

FIG. 3 is a flow diagram illustrating a process of generating training data for one or more machine learning models, in accordance with some implementations of the present technology. At act 302, process 300 may obtain a set of real estate listings. The set of real estate listings can include information of real estate properties that are (i) currently available or (ii) currently unavailable for sale. For example, the real estate listings can be records of real estate properties (e.g., historical real estate records, real estate information based on census information, etc.), currently listed real estate listings (e.g., based on real estate listings available on one or more websites or databases), user uploaded real estate listing information, or other real estate listing related information. Process 300 may obtain the set of real estate listings from a remote data store such as a real estate listing database (e.g., database 215). Each real estate listing of the set of real estate listings can be associated with a first geographic region. As an example, the first geographic region is a city block, a town, a county, a city, a state, a country, a continent, or other geographic region. Each real estate listing of the set of real estate listings may be associated with the same geographic region. For example, to generate accurate training data for a machine learning model (e.g., generate a selling soon prediction), real estate market's may vary region to region. For instance, a real estate market located in Orlando, FL may be a “hotter” market than in Scottsdale, AZ. To clarify, a “hotter” market may indicate that more real estate properties are selling more quickly (e.g., high demand, low supply) than in a “colder” market where real estate properties sell less quickly (e.g., low demand, high supply). As another example, the average home in Orlando, FL may sell within 15 days of the home becoming available on the market as opposed to the average home in Scottsdale, AZ, which may on average sell within 30 days of the home becoming available. Thus, regional differences between real estate markets may be valuable to account for when predicting whether homes will sell faster.

Each real estate listing of the set of real estate listings can be associated with a days-sold value. For instance, where the set of real estate listings are historical real estate listings (e.g., indicating real estate listings/properties that were once available on the market, but that are currently unavailable on the market), the real estate database can store information related to the days-sold value. The days-sold value indicates an amount of days, an amount of hours, or other time value since a given real estate listing was posted as available (e.g., available to be sold) to the time at which the real estate listing became unavailable on the market (e.g., pending, under contract, etc.). For example, where the real estate listing became unavailable on Jun. 15, 2022 and the real estate listing was posted on Jun. 12, 2022 as available, the days-on-market value may indicate 3 days, 72 hours, or 4320 minutes.

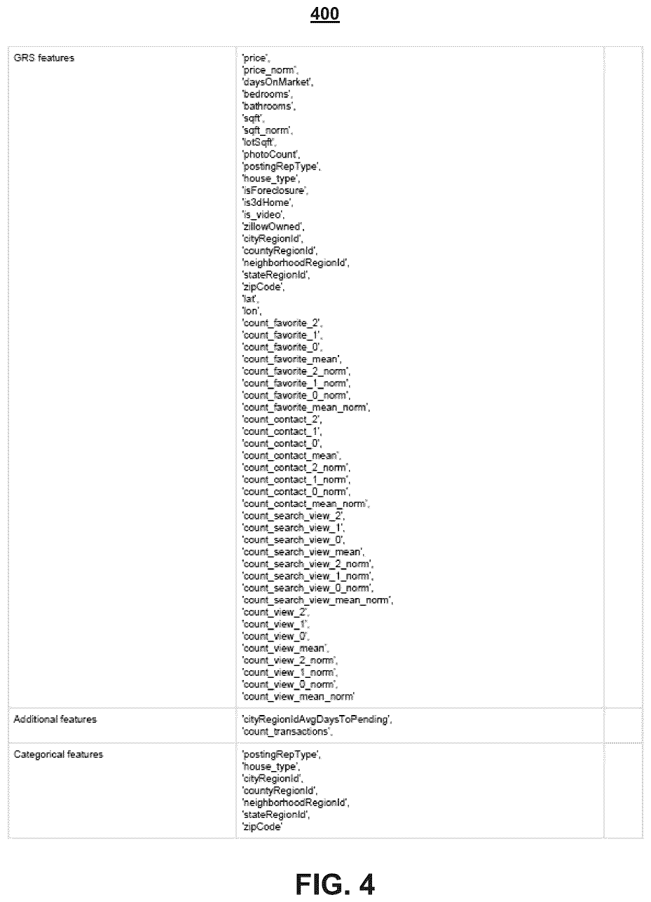

Additionally, each real estate listing of the set of real estate listings can be further associated with a set of home attributes that indicate features of the real estate listing. For example, home attributes can be attributes that are associated with a home/real estate property such as a number of bedrooms, a number of bathrooms, price information, a collection identifier associated with the property, size of the property, lot size, number of stories, location information (e.g., an address, GPS coordinates, etc.), waterfront property, oceanfront property, landlocked property, house type (e.g., condo, single family dwelling, commercial dwelling, townhouse, etc.), square footage of the property/home, or other home features or attributes. FIG. 4 indicates a table 400 of additional home attributes.

Moreover, each real estate listing of the set of real estate listings can further be associated with a set of user interaction data. The user interaction data can include one or more user interaction values. For example, the user interaction value can indicate a value or amount of user interactions associated with a real estate listing. For instance, the user interaction value may be an amount of webpage traffic (e.g., an amount of users visiting a webpage associated with a real estate listing), an amount of clicks of a real estate listing, an amount of saves of a real estate listing, an amount of time spent viewing a real estate listing, an amount of scrolling on a webpage associated with a respective real estate listing, or other webpage-traffic related user interaction value. Such user interaction values may be represented by an integer, a percentage, ratio, or other value corresponding to a respective metric. As an example, an amount of webpage traffic for a given real estate listing can be measured in a number of people visiting a webpage associated with the given real estate listing (e.g., an integer denoting how many people have visited the webpage). As another example, the amount of time spent viewing a given real estate listing can be measured in an amount of seconds users have collectively viewed a webpage associated with the given real estate listing.

Similarly, the user interaction data can indicate a value or amount of user interactions associated with a real estate listing attribute of a real estate listing of the set of real estate listings. For example, the user interaction value may be an amount of webpage traffic associated with a given real estate attribute of a real estate listing (e.g., an amount of users visiting a webpage associated with a real estate listing with a particular real estate attribute), an amount of clicks of a real estate listing associated with a given real estate attribute, an amount of saves of a real estate listing associated with a given real estate attribute, an amount of time spent viewing a real estate listing associated with a given real estate attribute, an amount of scrolling on a webpage associated with a respective real estate listing associated with a given real estate attribute, or other webpage-traffic related user interaction value associated with a given real estate attribute. Such user interaction values can be represented by an integer, a percentage, ratio, or other value corresponding to a respective metric. For instance, an amount of webpage traffic for a given real estate listing associated with a given real estate attribute can be measured in a number of people visiting a webpage associated with the given real estate listing further associated with a given real estate attribute (e.g., an integer denoting how many people have visited the webpage associated with a given real estate attribute). For example, a real estate listing associated with a real estate attribute of “paved driveway” may be associated with a webpage count of 50,000 users (e.g., indicating that a paved driveway is an “important” real estate attribute as opposed to a lower number of users visiting with webpage, such as 10 users). As another example, the amount of time spent viewing a given real estate listing associated with a given real estate attribute can be measured in an amount of seconds users have collectively viewed a webpage associated with the given real estate listing. For instance, a real estate listing associated with a real estate listing attribute of “renovated kitchen” may be associated with 4,000 hours (e.g., indicating that a renovated kitchen is an “important” real estate attribute as opposed to a lower amount of time spent viewing a real estate listing with other real estate attributes, such as 2 hours).

The user interaction values can be determined by a server (e.g., server 210) and stored in a real estate database (e.g., database 215) for future retrieval. For example, such user interaction values may be determined by a server (e.g., server 210) by monitoring data requests from one or more client devices (e.g., client device 205) interacting with a real estate database (e.g., database 215) via client devices Internet Protocol addresses and request message contents.

In some implementations, interaction values can have an interaction value type. A user interaction value type may correspond to the type of interaction a user has with a real estate listing, such as, but not limited to an amount of webpage traffic, clicks, saves, time spent viewing, amount of scrolling, amount of image searching, or other interaction types. In some implementations, the interaction values can be associated with one or more weights. Due to the different types of user interactions (e.g., amount of webpage traffic, clicks, saves, time spent viewing, amount of scrolling, amount of image searching, or other interaction types), one user interaction type may be weighted more heavily than others. For example, a “save” may be afforded more weight than a mere “click” (e.g., as a save may indicate that a real estate listing may be more popular and may sell sooner as compared to a user simply clicking on the real estate listing). In some implementations, the user interaction values for a given real estate listing can be averaged based on a weighted average. For example, process 300 may determine a weighted user interaction average for each real estate listing of the set of real estate listings. The weighted average may be represented by WA=((W1)(UT1)*(W2)(UT2)* . . . *(WN)(UTN))/(W1+W2+ . . . +WN) where WN represents a weight corresponding to a particular user interaction type (UTN), the UTN represents a value associated with an interaction type, and N represents an index associated with an amount of user interaction types. In this way, as will be explained later, when a machine learning model is trained, user interaction data of real estate listings is accounted for when determined whether a given real estate listing will sell soon—thereby generating more accurate and trustworthy predictions.

At act 304, process 300 can generate training data. For example, process 300 may generate training data for one or more prediction models (e.g., machine learning models). Process 300 may extract the days-sold value and the set of home attributes from each real estate listing of the set of real estate listings. Process 300 then uses the extracted days-sold values and the sets of home attributes to generate training data for a machine learning model. In some implementations, process 300 uses the extracted days-sold values and the sets of home attributes to generate a distribution of days-sold values that correspond to a given geographic region (e.g., due to the set of real estate listings being associated with a first geographic region).

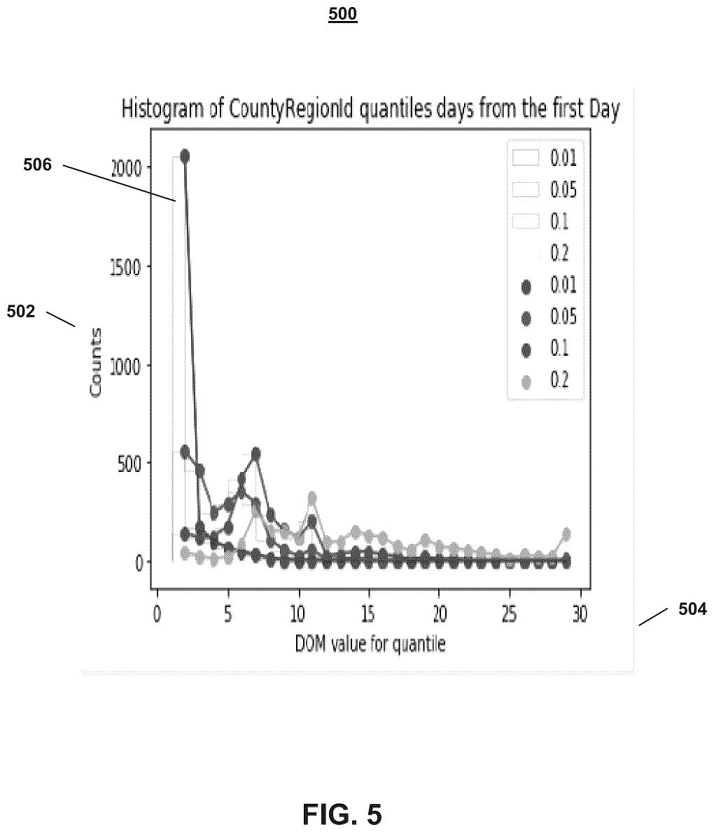

Referring to FIG. 5, the distribution can be a histogram of real estate listing counts with respect to how may days it took between a real estate listing having been available and unavailable (e.g., days-sold). For example, the y-axis 502 indicates an amount (e.g., a count) of real estate listings of the set of real estate listings, and the x-axis 504 indicates an amount of days.

Using the distribution, process 300 can perform a binning algorithm on the distribution using a set of predetermined quantile values to determine a set of threshold days-sold values that correspond to the set of predetermined quantile values. For example, the binning algorithm may be a simple binning process where each bin corresponds to a single day. For instance, first bin 506 of distribution 500 may indicate that 2000 real estate listings of the first set of real estate listings have sold within one day of being available on the market. Each bin of the bins generated (e.g., as indicated by the rectangular boxes similar to first bin 506 of FIG. 5), may be non-overlapping intervals of days-sold values.

Each quantile value of the set of predetermined quantile values can indicate a portion of the distribution. For example, the set of predetermined quantile values may indicate a percentage of the histogram with respect to the counts of the set of real estate listings and the days-sold values. For instance, the quantile values may be values such as [0.001, 0.005, 0.01, 0.05, 0.1, 0.2]. In some implementations, the quantile values may correspond to percentages such as [0.1%, 0.5%, 1%, 5%, 10%, 20%]. Process 300 can use the set of quantile values to determine how many days it took for a real estate listing to sell from when the real estate listing was listed as available on the market. That is, process 300 may determine based on the set of quantile values, a set of threshold days-sold values that correspond to [0.1%, 0.5%, 1%, 5%, 10%, 20%] of the distribution. For example, where a given quantile value is 0.5%, process 300 determines that, for a real estate listing of the set of real estate listings to sell 95% faster than all other real estate listings of the set of real estate listings, it will take 7 days to sell (e.g., indicating a threshold days-sold value). To clarify, the threshold days-sold value of 7 days may indicate that if a given real estate listing has sold in 7 days, that the real estate listing has sold faster than 95% of all other real estate listings in the set of real estate listings.

In some implementations, process 300 can assign or update a days-sold value to a predetermined days-sold value. To ensure that a machine learning model configured to generate accurate predictions on whether a given real estate listing will sell soon, real estate listings that have been listed for more than a maximum amount of days (or other time metric) can be assigned to an updated days-sold value. For instance, real estate listings may have been available on the market for an exorbitant amount of time (e.g., months, years, decades, etc.). Therefore, to avoid generating predictions indicating that a real estate property will “sell soon in 2 years” (e.g., not making logical sense and causing distrust with customers using the system), real estate listings that have been on the market for a long time may be assigned to a predetermined days-sold. For instance, such real estate listings may be updated to reflect a days-sold value of 29 days (or other predetermined days-sold value). Process 300 may parse through each real estate listing of the set of real estate listings and may determine whether a respective real estate listing has a days-sold value that exceeds a predetermined days-sold value. In response to process 300 determining that the respective real estate listing has a days-sold value that exceeds a predetermined days-sold value, process 300 updates the days-sold value to the predetermined days-sold value. As an example, if a given real estate listing currently has a days-sold value of 322 days, process 300 may update the days-sold value to a predetermined days-sold value (e.g., such as 29 days). Although 29 days is given as an example of the predetermined days-sold value, it should be noted that any predetermined days-on-market value may be used. For instance, process 300 may obtain a user input via a graphical user interface (GUI), indicating a predetermined days-sold value. For example, a real estate auditor may adjust the predetermined days-sold value to a larger or smaller value. A larger value can allow for a wider range of predictions indicating when real estate listings will sell soon (e.g., in the case of real estate market regions that consistently are “slow” or “low in demand, high in supply”), whereas a smaller value can allow for a more narrow range of predictions (e.g., in the case of a real estate market region that are consistently “hot” or “high in demand, low in supply).

In some implementations, process 300 can assign or update a days-sold value based on an updated real estate listing attribute. Real estate listings may have one or more attributes changed over the time at which they are listed to the current time/date. For example, a given real estate listing may be updated with a more competitive price if the original price did not gain enough attention. As another example, a given real estate listing may sell (or go pending, under contract, or otherwise become unavailable) and may be re-listed. Such real estate listings may therefore have a higher days-sold value (e.g., as the original days-sold value may be added to the days-sold value one the listing was re-priced, re-listed, or other attribute was updated/changed). Therefore, as a real estate listing attribute may be updated, the days-sold value can be updated to reflect any change to ensure the system has the most accurate training data.

In such a case, process 300 updates a days-sold value to an updated days-sold value based on a detected-updated real estate listing attribute. For example, process 300 detects whether a real estate listing attribute of the set of real estate listing attributes have changed. For instance, process 300 may access historical real estate listing data (e.g., from database 215) corresponding to a given real estate listing to determine whether there has been a change to any of the real estate listing attributes of the set of real estate listing attributes. The historical real estate listing data may include timestamps indicating (i) when the given real estate listing was originally listed (or available), (ii) when a real estate attribute of the given real estate listing was changed/updated, (iii) when the given real estate listing was sold or re-listed. Process 300 can use such timestamp information to determine an updated days-sold value by determining an amount of time between when the real estate listing last sold and when a real estate listing attribute was updated/changed (e.g., when the real estate listing was re-listed as available, when the price changed/updated, or other attributed was updated). Based on the determined amount of time, process 300 determines the updated days-sold value, and assigns the given real estate listing the updated days-sold value. As an example, where a real estate listing's days-sold value is currently 22 days, the real estate listing last sold on 6/20/2022, and the price was updated on 6/15/2022, then process 300 may determine that the updated days-sold value is 5 days, and may update the real estate listing's days-sold value from 22 to 5 days.

In some implementations, process 300 can label real estate listings of the set of real estate listings as a positive or negative example. For example, once quantiles have been determined (and their corresponding threshold days-sold values), it may be advantageous to label real estate listings as positive or negative examples to generate robust training data for a machine learning model. A positive label may indicate that a real estate listing is a selling-soon real estate listing while a negative label is a real estate listing that is not a selling soon real estate listing. Furthermore, as each real estate listing of the set of real estate listings may have different home attributes, customers who have purchased such properties may have varying interests. This may cause some real estate listings to sell faster or slower than others. For example, a real estate listing that is associated with a foundation in need of repair, water damage, and a high asking price may not sell quickly. As such, properties similar to this (e.g., that have been on the market for a long time) may not be a good indicator of how “hot” or “cold” a market is, or a property that may sell soon. Similarly, some properties may have been listed on the market for more than a predetermined maximum of days (e.g., a maximum days-sold threshold value). For example, the predetermined maximum of days may be 28 days, 30 days, 60 days, 365 days, etc. Therefore, when generating the training data for a machine learning model (e.g., used to predict whether homes will sell soon), as will be explained later, to prevent a home from being associated with a selling-soon label that has been listed for more than a maximum number of days, process 300 labels real estate listings of the set of real estate listings as positive or negative examples.

In some implementations, real estate listings can be labeled as a positive example based on a condition. For example, process 300 can obtain a predetermined condition from the real estate database (e.g., database 215). The predetermined condition may be a mathematical formula such as min_daysOnMarket<=min(quantile, maximum_daysOnMarket) where the min_daysOnMarket corresponds to a real estate listing's days-sold value, min indicates the minimum, quantile is a days-sold value corresponding to the predetermined quantile value, and maximum_daysOnMarket indicates a predetermined maximum days-on-market threshold value.

The predetermined maximum days-on-market threshold value can be predetermined value indicating a maximum number of days to which a real estate listing of the set of real estate listings may be labeled as a positive example. An issue common with real estate listing reporting is that some geographic areas do not report pending status (e.g., when a home is unavailable for purchase). To overcome such issue, a maximum days-on-market value can be used to ensure that homes that have been listed for a significant amount of time do not negatively impact the labeling of training data, which may lead to an improved method for predicting whether real estate properties will sell soon, thereby further leading to an improved user experience. To clarify, a real estate listing may be labeled as a positive example (e.g., for training data purposes) where the predetermined condition is satisfied. Additionally, the predetermined quantile value may be a default quantile value (e.g., 0.1%, 0.5%, . . . 20%, etc.) or may be selected based on a user input. For example, where a real estate database auditor would like to expand or reduce the amount of positive labels being assigned to real estate listings, the real estate database auditor may select a quantile value to be used.

In some implementations, process 300 labels each real estate listing of the first set of real estate listings as a positive or negative example based on the predetermined condition. For example, process 300 can compare the days-sold value of each real estate listing of the set of real estate listings to a threshold days-sold value corresponding to the selected quantile value. Process 300 may determine, based on the predetermined condition, whether the predetermined condition is satisfied. For example, if the days-sold value is less than or equal to the minimum of (i) the threshold days-sold value corresponding to the selected quantile value and (ii) the maximum days-on-market threshold value, then process 300 determines that the predetermined condition is satisfied, and label the respective real estate listing as a positive example. On the contrary, if days-on-market value is greater than the minimum of (i) the threshold days-sold value corresponding to the selected quantile value and (ii) the maximum days-sold threshold value, then process 300 determines that the predetermined condition is not satisfied, and may label the respective real estate listing as a negative example.

In one use case, where the selected quantile value is 0.5%, process 300 may determine from the distribution that the quantile value corresponds to a threshold days-sold value of 7 days. Process 300 then applies the predetermined condition to a real estate listing of the set of real estate listings to label the real estate listing as a positive or negative example. For instance, where a real estate listing's days-sold value indicates 5 days, and the maximum days-sold threshold value is 28 days, then process 300 determines whether 5 days<=min (7 days, 28 days). That is, since 5 days is less than or equal to the minimum of 7 and 28, the real estate listing is labeled as a positive example. On the contrary, if the real estate listing's days-sold value indicated 10 days, then the real estate listing is labeled as a negative example (e.g., because 10 is not less than or equal to the minimum of 7 and 28).

At act 306, process 300 can train a machine learning model based on training data. For example, as explained above, a machine learning model may be trained based on training data. In particular, process 300 uses the labeled set of real estate listings (e.g., as labeled in act 304) as training data for the machine learning model. For example, process 300 may train a machine learning model based on (or using) the labeled set of real estate listings. The machine learning model may be any machine learning model configured for generating selling soon predictions. The selling soon predictions can be related to (i) whether a given real estate listing will sell soon, (ii) how many days (or other time-related value) will a given real estate listing sell, (iii) probability related to whether a given real estate listing will sell faster than a percentage (or quantile, or other value corresponding to a quantile) of real estate listings within a given geographic region, or (iv) other prediction related to the selling (or unavailability) of a real estate listing. The machine learning model may be a Neural Network (NN), Convolutional Neural Networks (CNN), Recurrent Neural Network (RNN), Support Vector Machines (SVM), or other machine learning models. Such machine learning models may be stored in the real estate database (e.g., database 215). During training, the machine learning model may learn one or more relationships between the days-sold values, real estate listing attributes, and user interaction data with real estate listings. For example, during training, the machine learning model may discover that listings with particular attributes and listings that receive particular user interactions values may correlate to the days-sold values. As such, the machine learning model may use the relationships to aid generating selling soon predictions.

In some implementations, the machine learning models can include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some implementations, each individual neural unit may have a summation function which combines the values of all its inputs together. In some implementations, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some implementations, neural networks may include multiple layers (e.g., where a signal path traverses from front layers to back layers). In some implementations, backpropagation techniques may be utilized by the neural networks, where forward stimulation is used to reset weights on the “front” neural units. In some implementations, stimulation and inhibition for neural networks may be more free-flowing, with connections interacting in a more chaotic and complex fashion.

As an example, the machine learning model can take inputs and provide outputs. In one use case, outputs can be fed back to machine learning model as input to train machine learning model (e.g., alone or in conjunction with user indications of the accuracy of outputs, labels associated with the inputs, or with other reference feedback information). In another use case, machine learning model can update its configurations (e.g., weights, biases, or other parameters) based on its assessment of its prediction (e.g., outputs) and reference feedback information (e.g., user indication of accuracy, reference labels, or other information). In another use case, where machine learning model is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed.

As an example, where the machine learning models include a neural network, the neural network can include one or more input layers, hidden layers, and output layers. The input and output layers may respectively include one or more nodes, and the hidden layers may each include a plurality of nodes. When an overall neural network includes multiple portions trained for different objectives, there may or may not be input layers or output layers between the different portions. The neural network may also include different input layers to receive various input data. Also, in differing examples, data may be input to the input layer in various forms, and, in various dimensional forms, may be input to respective nodes of the input layer of the neural network. In the neural network, nodes of layers other than the output layer are connected to nodes of a subsequent layer through links for transmitting output signals or information from the current layer to the subsequent layer, for example. The number of links may correspond to the number of nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer can be again input to the same node or layer at a subsequent time, while in a bi-directional structure, forward and backward connections may be provided. The links are also referred to as connections or connection weights, as referring to the hardware implemented connections or the corresponding “connection weights” provided by those connections of the neural network. During training and implementation such connections and connection weights can be selectively implemented, removed, and varied to generate or obtain a resultant neural network that is thereby trained and that may be correspondingly implemented for the trained objective, such as for any of the above example recognition objectives.

In some implementations, the machine learning model can be trained based on training data comprising (i) the labeled set of real estate listings, (ii) a set of home attributes corresponding to each real estate listing of the set of real estate listings, and (iii) user interaction data corresponding to each real estate listing of the set of real estate listings to generate selling soon predictions related to (i) whether a given real estate listing will sell soon, (ii) how many days (or other time-related value) will a given real estate listing sell, (iii) probability related to whether a given real estate listing will sell faster than a percentage (or other value) of real estate listings within a given geographic region, or (iv) other prediction related to the selling (or unavailability) of a real estate listing. For example, the labeled set of real estate listings includes whether a given real estate listing is associated with positive label or a negative label. As discussed above, a positively labeled real estate listing may include a days-on-market value that has satisfied the predetermined condition. A negatively labeled real estate listing may include a days-on-market value that has been updated (e.g., to a predetermined days-on-market value, in accordance with one or more implementations). As another example, the set of home attributes corresponding to a given real estate listing of the set of real estate listings may indicate features of the given real estate listing. As yet another example, the user interaction data corresponding to a given real estate listing of the set of real estate listings may indicate a value or amount of user interactions associated with a real estate listing, in accordance with one or more implementations.

In some implementations, the machine learning model can be trained on such training data. For instance, machine learning model may take the training data as input, and generate a prediction indicating an real estate listing that may sell the fastest with respect to all other real estate listings of the set of real estate listings. As another example, the machine learning model may generate a prediction indicating how many days the home will sell. As yet another example, the machine learning model may generate a prediction indicating a percentage of how fast a real estate property will sell with respect to all of other real estate listing of the set of real estate listings with respect to a given region (e.g., 95% faster than, 90% faster than 80% faster than other homes with respect to a given region, etc.). In some implementations, the generated prediction(s) may be fed back into machine learning model to update one or more configurations (e.g., weights, biases, or other parameters) based on its assessment of its prediction (e.g., outputs) and reference feedback information (e.g., user input of an indication of accuracy, reference labels, or other information).

In some implementations, process 300 can repeat based on a temporal condition. As the real estate market may change throughout time, it is advantageous to re-train machine learning models periodically. For example, it is well known that real estate markets fluctuate based on a given time frame of a year, the general economy, or other factors. In the summer, real estate properties often gain more attention and thereby, may sell faster than in the winter months. Similarly, when the economy is doing poorly, homes may not sell as fast, which may impact selling soon predictions. Thus, to ensure that selling soon predictions are accurate with respect to changes occurring within a real estate market, process 300 can repeat based on a temporal condition. The temporal condition may be every hour, every day, every week, every month, every year, etc. In one use case, where the temporal condition is every day, process 300 may repeat every day. That is, the machine learning model can be re-trained based on updated training data obtained via acts 302-306 of process 300.

### Providing Visual Indications of Time Sensitive Information

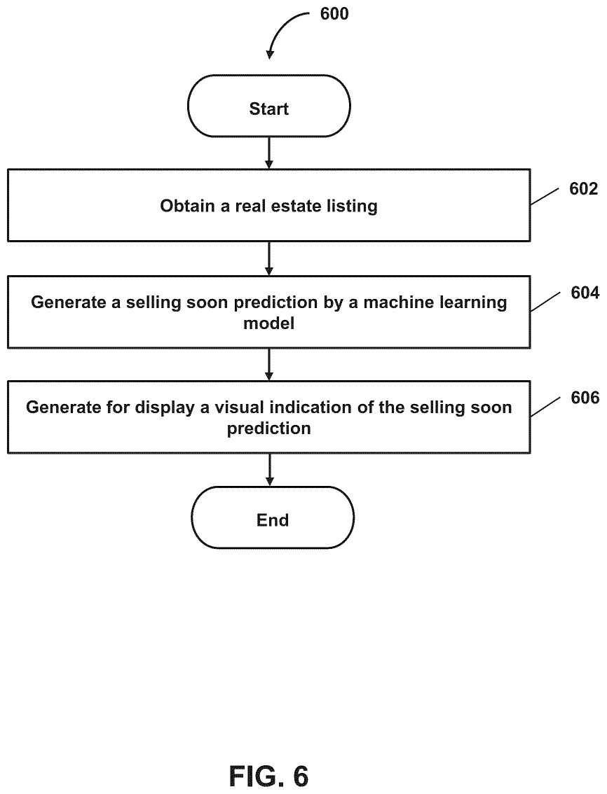

FIG. 6 is a flow diagram illustrating a process of providing visual indications of time sensitive real estate listing information on a Graphical User Interface (GUI), in accordance with some implementations of the present technology.

At act 602, process 600 can obtain a real estate listing. For example, process 600 obtains a subject real estate listing where the subject real estate listing indicates a real estate listing to which a selling soon prediction may be generated. Process 600 can obtain the subject real estate listings from a remote data store such as a real estate listing database (e.g., database 215). The subject real estate listing can be associated with subject real estate listing information (e.g., a days-on-market value, real estate listing attributes, user interaction data, or other information). For example, the subject real estate listing may be associated with a days-on-market value. The days-on-market value may indicate an amount of days between when the real estate listing became available (e.g., available to sell) and the current time/date. For example, where the current date is Jun. 15, 2022 at 1:00 p.m., and the home was listed (e.g., available to sell) on Jun. 14, 2022 at 1:00 p.m., the days-on-market value for the subject real estate listing may be 1 day. In some implementations, the days-on-market value can be measured in an amount of seconds, minutes, hours, days, weeks, months, years, or other metric for measuring the time between a real estate listing becoming available and the current time/date.

Additionally, the subject real estate listing can further be associated with a geographic region. As discussed above, the geographic region may be a city block, a town, a county, a city, a state, a country, a continent, or other geographic region. In some implementations, the geographic region can be the first geographic region (e.g., to which a prediction model was trained on). As discussed above, to account for market to market differences with respect to a geographic region, when a selling soon prediction is to be made, the geographic region of the subject real estate listing may match the geographic region of the set of real estate listings (to which the machine learning model is trained on). Moreover, the subject real estate listing can further be associated with a set of home attributes. As discussed above, the home attributes may indicate features of the real estate listing. Lastly, the subject real estate listing may also be associated with a set of user interaction data.

At act 604, process 600 can generate a selling soon prediction. For example, process 600 may generate a selling soon prediction, by a machine learning model, using the subject real estate listing information. In some implementations, the selling soon prediction indicates (i) whether a the subject real estate listing will sell soon, (ii) how many days (or other time-related value) will the subject real estate listing sell, (iii) probability related to whether the subject real estate listing will sell faster than a percentage (or quantile, or other value corresponding to a quantile) of real estate listings within a given geographic region, or (iv) other prediction related to the selling (or unavailability) of the subject real estate listing.

For example, where the selling soon prediction indicates whether a the subject real estate listing will sell soon, the output of the machine learning model may be an indication of “Yes,” “No,” “This listing is predicted to sell soon,” or other indication related to whether the real estate listing will sell soon (e.g., with respect to the training data to which the machine learning model was trained on). As another example where the selling soon prediction indicates how many days (or other time-related value) will the subject real estate listing sell, the machine learning model can output a day-of-sale value corresponding to the subject real estate listing. The day-of-sale value may be related to an amount of days the subject real estate listing will sell. For example, the day-of-sale value may be an amount of seconds, minutes, hours, days, weeks, months, or years in which the subject real estate listing will sell. For instance, the day-of-sell value may indicate “predicted to sell in 5 minutes,” “predicted to sell in 2 hours,” “predicted to sell in 1 day,” “predicted to sell in 2 days,” “predicted to sell this month,” or other indication. In other implementations, the day-of-sell value can be a date in which the subject real estate listing will sell. For example, the day-of-sell value may indicate “predicted to sell on 6/15/2022,” “predicted to sell on 8/19/2022” or other date. As another example, where the selling soon prediction indicates probability related to whether the subject real estate listing will sell faster than a percentage of real estate listings within a given geographic region, the machine learning model can output a prediction indicating “This listing is predicted to sell sooner than 98% of nearby listings.”

In some implementations, the machine learning model can be configured to generate a particular type of selling soon prediction. For example, selling soon predictions can each have a type such as (i) whether a the subject real estate listing will sell soon, (ii) how many days (or other time-related value) will the subject real estate listing sell, (iii) probability related to whether the subject real estate listing will sell faster than a percentage of real estate listings within a given geographic region, or (iv) other prediction related to the selling (or unavailability) of the subject real estate listing. The machine learning model can be configured to generate a particular type of selling soon prediction based on a user input (e.g., a user such as a real estate database auditor selecting the type of selling soon prediction to be outputted). Additionally or alternatively, the machine learning model may be configured to generate a particular type of selling soon prediction based on a default type. For example, the default type may be any one of the selling soon prediction types as described above. The default type may be a predetermined default type set by the system.

In some implementations, process 600 can generate a selling soon prediction, by a machine learning model, using the subject real estate listing information. For example, process 600 can provide a machine learning model with the days-on-market value, the set of home attributes associated with the subject real estate listing, or interaction data associated with the subject real estate listing as input to the machine learning model to generate the selling soon prediction.

In some implementations, process 600 can select a machine learning model. For example, a real estate database (e.g., database 215) can store a set of machine learning models. Each machine learning model of the set of machine learning models may each be pre-trained or pre-configured based on training data corresponding to a given geographic region. As discussed above, to account for regional market differences (e.g., where one location may be a “hot market” where real estate properties are selling faster and another location may be a “cold” real estate market where real estate properties are selling slower), when generating selling soon predictions for a subject real estate listing, a machine learning model can be selected based on the geographic region of real estate listings the machine learning model was trained on. For example, a first machine learning model may be trained on real estate listing information associated with real estate listings located in Seattle, WA. As another example, a second machine learning model may be trained on real estate listing information associated with real estate listings located in Rensselaer County, NY. Therefore, process 600 can determine a geographic region that is associated with the subject real estate listing, and can select a corresponding machine learning model (e.g., stored in the real estate database) to generate selling soon predictions. For instance, process 600 may perform Natural Language Processing on a real estate listing description associated with the subject real estate listing to extract the geographic region to which the subject real estate listing is associated with. Using the extracted geographic region, process 600 determines a machine learning model from the set of machine learning models that is associated with the extracted geographic region. Process 600 then selects the machine learning model that is associated with the extracted geographic region to generate selling soon predictions related to the subject real estate listing. In this way, the system reduces the amount of computer processing resources needed to generate selling soon predictions as such pre-trained or pre-configured machine learning models may be obtained from the real estate database that to not require additional training.

In some implementations, process 600 can train a machine learning model. For example, a real estate database (e.g., database 215) can store a set of untrained machine learning models. Process 600 may determine, based on the subject real estate listing, the geographic region to which the subject real estate listing is associated with. Process 600 then accesses the real estate database to obtain a set of real estate listings. For instance, each real estate listing of the set of real estate listings may be associated with the geographic region to which the subject real estate listing is associated with, a days-sold value, and a second set of home attributes. Upon process 600 obtaining the set of real estate listings, process 600 may invoke a process that is the same or similar to process 300. More particularly, process 600 may evoke acts 304-306 of process 300 to generate the training data and train the machine learning model.

In some implementations, process 600 may not generate a selling soon prediction for the subject real estate listing using the subject real estate listing's user interaction data. For example, the subject real estate listing may not have been listed (or available) on the real estate database for long time (or has been listed less than a minimum days-on-market value). As such, the user interaction data of the subject real estate listing may not be “good data” to be used when generating a selling soon prediction. For instance, where the subject real estate listing was listed less than the minimum days-on-market value, only a very small amount of user interaction data may have been collected by the real estate database. The minimum days-on-market value may be a predetermined amount of seconds, hours, days, weeks, months, years, or other metric. As an example, the minimum days-on-market value may be 1 day, 2 days, 3 days, or other value, in accordance with one or more implementations. Process 600 can compare the days-on-market value associated with the subject real estate listing to the minimum days-on-market value. If the days-on-market value is greater than or equal to the minimum days-on-market value, then process 600 generates the selling soon prediction for the subject real estate listing based on the days-on-market value, the set of home attributes, and the user interaction data associated with the subject real estate listing. However, if the days-on-market value is less than the minimum days-on-market value, then process 600 generates the selling soon prediction for the subject real estate listing based on the days-on-market value and the set of home attributes associated with the subject real estate listing without the user interaction data associated with the subject real estate listing. In this way, the system ensures accurate selling soon predictions thereby increasing users' trust and improving the user experience.

At act 606, process 600 can generate for display, a visual indication of the selling soon prediction. For example, process 600 may generate, for display on a graphical user interface (GUI), in association with a real estate listing, a visual indication of the selling soon prediction. For example, process 600 may use the selling soon prediction to be displayed on a GUI associated with the subject real estate listing, where the GUI displays information of the subject real estate listing. The selling soon prediction may be displayed on a real estate listing photocard (e.g., thumbnail image) of the subject real estate listing, an image of a subject real estate listing, in a portion of the subject real estate listing description, or otherwise displayed in association with the subject real estate listing.

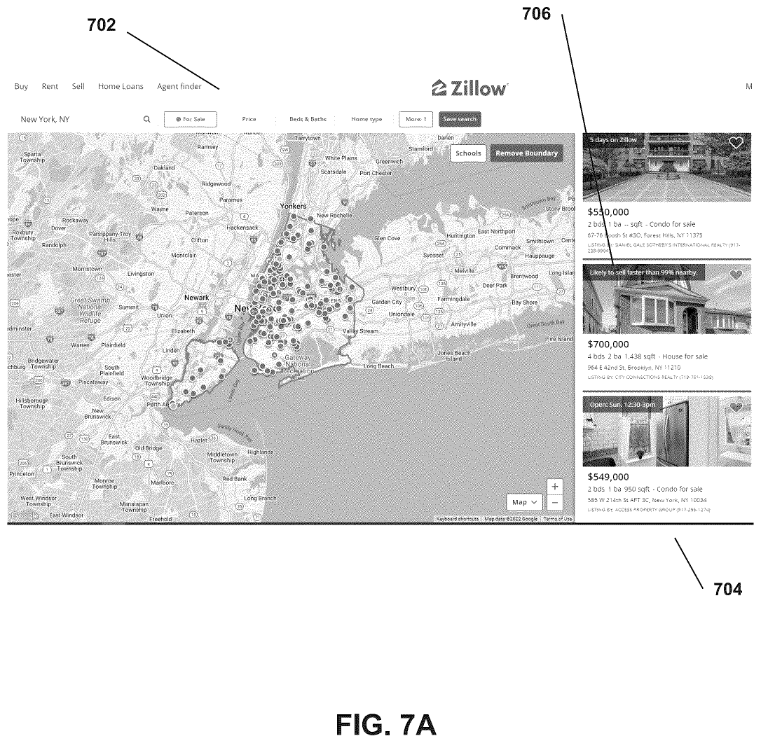

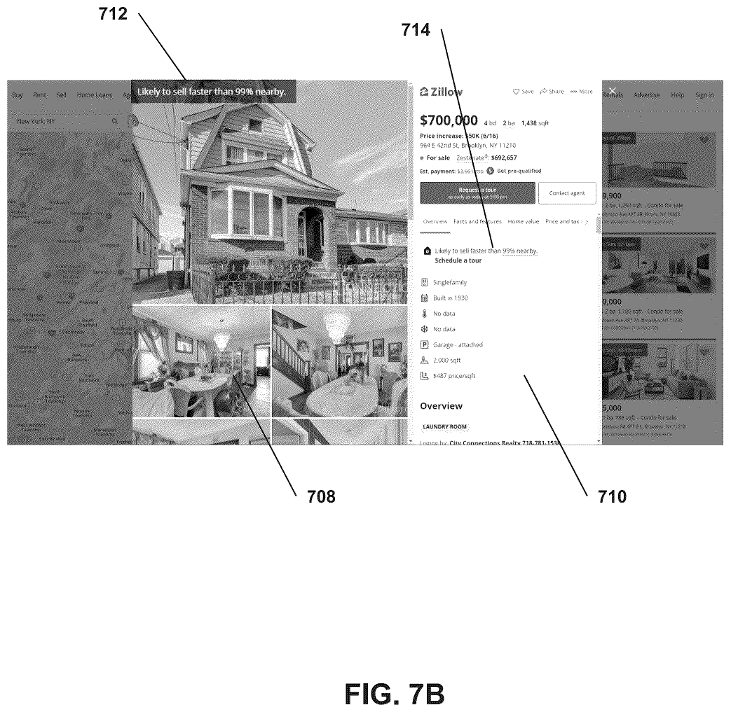

As an example, the real estate listing photocard may visually appear to a user on a real estate listing search-result user interface. As such, by displaying the selling soon prediction on the real estate listing photocard, users may quickly identify real estate listings that may sell soon, which may prompt the user to purchase the home where otherwise, the user may lose out on purchasing such home—thereby improving the user experience. Referring to FIG. 7A, a search result page 702 for real estate listings in New York City, NY is provided. Search results 704 can be displayed with one or more real estate listings and the real estate listings of the search results 704 can include first selling soon prediction 706. In this particular example, as shown, first selling soon prediction 706 indicates that the subject real estate listing is “likely to sell faster than 99% nearby.”

As another example, the selling soon prediction may be displayed on an image of the subject real estate listing. For instance, where a user may click on the subject real estate listing (e.g., via a webpage), by displaying the selling soon prediction on an image of the subject real estate listing, the user may be more likely to notice the selling soon prediction (e.g., as opposed to reading through the real estate listing description). As yet another example, the selling soon prediction may be displayed in a portion of the subject real estate listing description. As a user reads through the real estate listing description to gain more knowledge about the real estate property, the user may be provided with a visual indication of the selling soon prediction, thus ensuring the user is made aware of such time-sensitive information. Referring to FIG. 7B, images 708 of a subject real estate listing are shown with the real estate listing description 710. As discussed above, a selling soon prediction may be displayed on an image of the subject real estate listing, such as second selling soon prediction 712. Additionally, a selling soon prediction may be displayed in at least a portion of the subject real estate listing description, such as third selling soon prediction 714. It should be noted, however, that other selling soon predictions may be presented, in accordance with one or more implementations.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A system for improving real estate-related user interfaces by providing visual indications of time sensitive real estate listing information on a graphical user interface (GUI), the system comprising:
at least one processor;
at least one remote data store storing real estate listings, wherein each real estate listing is associated with (i) a geographic region, (ii) a days-sold value, and (iii) a set of home attributes; and
at least one memory coupled to the at least one processor and storing instructions that, when executed by the at least one processor, perform operations comprising:
accessing the remote data store to obtain a set of real estate listings of homes sold in a first geographic region;
extracting, from each real estate listing of the set of real estate listings, the days-sold value and the set of home attributes, to generate training data for a machine learning model;
training the machine learning model using the training data;
accessing the remote data store to obtain a subject real estate listing of a home currently listed for sale in the first geographic region, wherein the subject real estate listing is further associated with a days-on-market value;
apply the machine learning model to generate a selling soon prediction indicating a number of days in which the subject real estate listing is expected to sell; and
generating for display, on a GUI displaying information of the subject real estate listing, a graphical component corresponding to the generated selling soon prediction wherein the graphical component visually indicates the number of days in which the subject real estate listing is expected to sell.

2. The system of claim 1, wherein generating the training data further comprises:
generating a distribution indicating days-sold values versus real estate listing counts, using the days-sold values from the set of real estate listings;
determining a set of threshold days-sold values, using a set of predetermined quantile values, by binning the distribution of the days-sold values into bins corresponding to the predetermined quantile values, wherein each quantile value of the set of predetermined quantile values indicates a portion of the distribution of the days-sold values and wherein each bin of the bins indicate a second days-sold value; and
selecting, based on a user input, a first quantile value from the set of predetermined quantile values.

3. The system of claim 2, wherein generating the training data further comprises:
determining, based on the first quantile value, a respective second days-sold value that corresponds to the first quantile value;
for each real estate listing of the set of real estate listings:
comparing the days-sold value to the respective second days-sold value corresponding to the first quantile value; and
labeling the respective real estate listing as a positive example, based on the comparison, in response to the days-sold value being less than or equal to a minimum of (i) the respective second days-sold value corresponding to the first quantile value and (ii) a predetermined maximum days-sold threshold value.

4. The system of claim 2, wherein generating the training data further comprises:
determining, based on the first quantile value, a respective second days-sold value that corresponds to the first quantile value;
for each real estate listing of the set of real estate listings:
comparing the days-sold value to the respective second days-sold value corresponding to the first quantile value; and
labeling the respective real estate listing as a negative example, based on the comparison, in response to the days-sold value being greater than a minimum of (i) the respective second days-sold value corresponding to the first quantile value and (ii) a maximum days-sold threshold value.

5. A method for improving real estate-related user by providing visual indications of time sensitive real estate listing information on a graphical user interface (GUI), comprising:
accessing a remote data store to obtain a subject real estate listing, wherein the subject real estate listing is associated with a first days-on-market value and a first set of home attributes;
applying a machine learning model to generate a selling soon prediction indicating a day-of-sale value corresponding to the subject real estate listing; and
generating, for display on a GUI displaying information of the subject real estate listing, a visual indication of the day-of-sale value.

6. The method of claim 5, wherein the first days-on-market value indicates a number of days between the real estate listing being available to sell and the current date.

7. The method of claim 5, further comprising:
determining a geographic region to which the subject real estate listing is associated with;
accessing the remote data store to obtain a set of real estate listings, wherein each real estate listing is associated with (i) the geographic region, (ii) a days-sold value, and (iii) a second set of home attributes;
extracting, from each real estate listing of the set of real estate listings, the days-sold value and the second set of home attributes, to generate training data for the machine learning model; and
training the machine learning model based on the set of training data.

8. The method of claim 7, wherein each real estate listing of set of real estate listings is further associated with user interaction information and wherein the machine learning model is further trained on the user interaction information associated with each real estate listing of the set of real estate listings.

9. The method of claim 8, wherein the user interaction information indicates an amount of (i) clicks, (ii) saves, (iii) time spent viewing, or (iv) scrolling on a webpage associated with a respective real estate listing of the set of real estate listings.

10. The method of claim 8, wherein the user interaction information indicates an amount of (i) clicks, (ii) saves, (iii) time spent viewing, or (iv) scrolling on a webpage associated with at least one home attribute respective of a real estate listing of the set of real estate listings.

11. The method of claim 5, wherein the prediction of the day-of-sale value further comprises:
applying the machine learning model to generate the day-of-sale value corresponding to the subject real estate listing, further using user interaction information associated with the subject real estate listing.

12. The method of claim 5, wherein the generating, for display on the GUI displaying information of the subject real estate listing, the visual indication of the day-of-sale value further comprises:
generating, for display on the GUI displaying the information of the subject real estate listing, the day-of-sale value on an image associated with the subject real estate listing.

13. One or more non-transitory computer-readable media comprising instructions that, when executed by one or more processors, cause operations comprising:
accessing a remote data store to obtain a subject real estate listing, wherein the subject real estate listing is associated with a first days-on-market value and a first set of home attributes;
applying a machine learning model to generate a selling soon prediction indicating a day-of-sale value corresponding to the subject real estate listing; and
generating, for display on a GUI displaying information of the subject real estate listing, a visual indication of the day-of-sale value.

14. The media of claim 13, wherein the first days-on-market value indicates a number of days between the real estate listing being available to sell and the current date.

15. The media of claim 13, the operations further comprising:
determining a geographic region to which the subject real estate listing is associated with;
accessing the remote data store to obtain a set of real estate listings, wherein each real estate listing is associated with (i) the geographic region, (ii) a days-sold value, and (iii) a second set of home attributes;
extracting, from each real estate listing of the set of real estate listings, the days-sold value and the second set of home attributes, to generate training data for the machine learning model; and
training the machine learning model based on the set of training data.

16. The media of claim 15, wherein each real estate listing of set of real estate listings is further associated with user interaction information and wherein the machine learning model is further trained on the user interaction information associated with each real estate listing of the set of real estate listings.

17. The media of claim 16, wherein the user interaction information indicates an amount of (i) clicks, (ii) saves, (iii) time spent viewing, or (iv) scrolling on a webpage associated with a respective real estate listing of the set of real estate listings.

18. The media of claim 16, wherein the user interaction information indicates an amount of (i) clicks, (ii) saves, (iii) time spent viewing, or (iv) scrolling on a webpage associated with at least one home attribute respective of a real estate listing of the set of real estate listings.

19. The media of claim 13, wherein the prediction of the day-of-sale value further comprises:
applying the machine learning model to generate the day-of-sale value corresponding to the subject real estate listing, further using user interaction information associated with the real estate listing.

20. The media of claim 13, wherein the generating, for display on the GUI displaying information of the subject real estate listing, the visual indication of the day-of-sale value further comprises:
generating, for display on the GUI displaying the information of the subject real estate listing, the day-of-sale value on an image associated with the subject real estate listing.
